(19) United States
(12) Patent Application Publication
(10) Pub. No.: US 2015/0363861 A1
(43) Pub. Date: Dec. 17, 2015

(54) SYSTEM AND METHOD FOR IMPROVED PERSONALIZATION USING BEACON TECHNOLOGY

(71) Applicant: Sailthru, Inc,, New York, NY (US)

(72) Inventors: Neil James Capel, New York, NY (US); David Hoerl, Bridgewater, NJ (US); Ian Bradford White, Brooklyn, NY (US)

(21) Appl. No.: 14/304,628

(22) Filed: Jun. 13, 2014

(51) Int. Cl. G06Q 30/06

(52) U.S. Cl. CPC G06Q 30/0631

(57) ABSTRACT

A system and method are disclosed for providing a targeted recommendation for a product or service. At least one database is accessed that includes software application information associated with at least one respective software application provided to each of a plurality of users, profile information of the users, user interest history information and inventory information associated with at least one product and/or service. Electronic use information associated with one of the software applications within a location at a given time is received and processed to associate the one respective software application with a respective one of the plurality of user devices. At least some of the electronic inventory information associated with one of the merchants is determined and a recommendation of a product and/or service associated with the one merchant is made.

### FIELD

The present invention relates generally to networking and, more particularly, to providing personalized service.

### BACKGROUND OF THE INVENTION

Various providers of products and services (e.g., merchants) continue to seek new ways to engage customers. Push notifications, for example, enable a merchant to send a message to a group of users at some specific time, for example to the users' mobile devices. When received, the devices create an alert, and the next time the users activate their devices, the notification is visible. The users then decide the next step. Moreover, many such alerts are generic and not of interest, and detract users' attention.

Unfortunately, it is recognized that too often users simply take no further action and/or forget about the message they just received.

### SUMMARY OF THE INVENTION

The present application addresses these and other concerns, including by providing merchants and other interested parties with new and powerful ways to engage users of mobile computing devices, such as smartphones and tablet computers.

In one or more implementations, the present application provides a targeted recommendation for a product or service. Using at least one processor, at least one database is accessed that includes electronic software application information associated with at least one respective software application provided to each of a plurality of users. The at least one database further includes electronic profile information associated with each of the plurality of respective users, and electronic user interest history information associated with at least one web page accessed by at least one of a plurality of respective user devices. Using the at least one processor, electronic use information associated with a respective one of the software applications that is active within a respective location at a respective time is received over a data communication network. The electronic use information is processed to associate the one respective software application with a respective one of the plurality of user devices. Moreover and based on at least some of the electronic user interest history information associated with the respective user device, a recommendation of a product and/or service associated with one merchant is determined using the at least one processor. The recommendation is provided to a computing device operated by a person associated with the one merchant.

In one or more implementations, receiving the electronic use information further comprises transmitting, using at least one transmitter, a notification that is receivable by the respective user device. In response to the transmitted notification from the respective user device, the electronic use information is received. The notification can be transmitted wirelessly over a low power radio frequency signal having a frequency range within about 2.40-2.480 GHz.

In one or more implementations, the electronic use information further includes at least one of: an identifier of a copy of the respective one software application; an identifier of the respective user device configured with the respective one software application; and an identifier of the one of the plurality of users.

In one or more implementations, providing the recommendation further comprises: determining, using the at least one processor, a location of the respective user device; and transmitting, using the at least one processor, the recommendation to the at least one computing device operated by the person associated with the one merchant based at least on the location of the respective user device. Moreover, determining the location of the respective user device can be performed as a function of at least one of: a global positioning system; and a location of the at least one transmitter and a value representing a signal strength of the notification received by the respective user device. Further, a plurality of computing devices that are each respectively operated by at least one person associated with the one merchant can be identified using the at least one processor, and based at least on the location of the respective user device, a respective computing device operated by the at least one person associated with the one merchant can be determined.

Moreover, in one or more implementations, the at least one database further includes electronic inventory information associated with at least one product and/or service respectively associated with each of a plurality of merchants. In such case(s) the step of determining the recommendation can be based on at least some of the electronic inventory information associated with the one merchant.

Other features and advantages of the present application will become apparent from the following description of the invention that refers to the accompanying drawings.

### BRIEF DESCRIPTION OF DRAWINGS/FIGURES

Further aspects of the present disclosure will be more readily appreciated upon review of the detailed description of its various embodiments, described below, when taken in conjunction with the accompanying drawings, of which:

FIG. 1 is a block diagram that illustrates an example arrangement of hardware devices in connection with an example implementation of the present application;

FIG. 2 is a block diagram that illustrates functional elements of one or more of a data processing apparatus and/or other computing device in accordance with one or more implementations of the present application;

FIG. 3 is a block diagram representing a plurality of modules that provide functionality shown and described herein;

FIG. 4 illustrates an implementation of the present patent application and illustrates an example retail establishment with adjacent parking lot;

FIG. 5 illustrates an example tablet computing device that is displaying a special offer in the form of a barcode;

FIG. 6 is an example flow diagram showing a routine that illustrates a broad aspect of a method for providing a product/service recommendation in accordance with an example implementation; and

FIG. 7 is another flowchart illustrating example steps associated with an example implementation.

### DETAILED DESCRIPTION

By way of overview and introduction, systems and methods are provided herein to engage user computing devices such as smart phones, PDAs or the like to generate notifications of opportunities in the marketplace. For example, product information, special offers, coupons or the like can be provided substantially automatically in response to a determination that a user computing device is present within a geographic area. The geographic area may be very small (e.g., a micro-location), such as a particular aisle in a store, or in a larger range, such as within dozens of meters (e.g., within a complete range of a signal transmitter). Thus, a user computing device within a geographical micro-location, such as a rack of clothes, a counter of a diner, an arbitrary area of yards or feet can be determined. The transmitter can be, for example, wirelessly transmitting a signal that is receivable by a mobile computing device and usable for the computing device to respond in a particular way. Once defined, when a user enters the predetermined space and it is determined that the user is a member, for example, of a designated campaign group, that the user has a user profile or entry in a database, or that the user is otherwise known to the merchant, then relevant information can be accessed to display to the user and/or to another party who can use the relevant information to interact with the user.

In one or more implementations, one or more computing devices are configured with Blue Tooth Low Energy (BTLE) devices, such either transmitters and/or receivers. This enables a computing device to detect and respond to a signal transmitted by a transmitter, such as a beacon.

In one or more implementations of systems and methods disclosed herein, when a user computing device responds to the transmitted signal, information can be accessed and/or received that represents the computing device, the user, and or activity associated therewith. For example, detailed information regarding a user's purchasing and browsing history can be accessed and used to engage the user in meaningful ways. Such information can be obtained or accessed from one or more databases that are accessible over a data communication network or locally. For example, information stored in one or more user profiles can be accessed to garner additional information associated with the user of the computing device. Furthermore, information can be obtained as a function of one or more email campaigns, such as shown and described in co-pending and commonly assigned U.S. patent application 61/816,127, the entirety of which is incorporated by reference as if expressly set forth herein. Alternatively (or in addition), information can be obtained as a function of one or more Push Notifications. The information can be used to generate a recommendation or other course of action, and can be delivered to a sales representative or other party associated with a merchant.

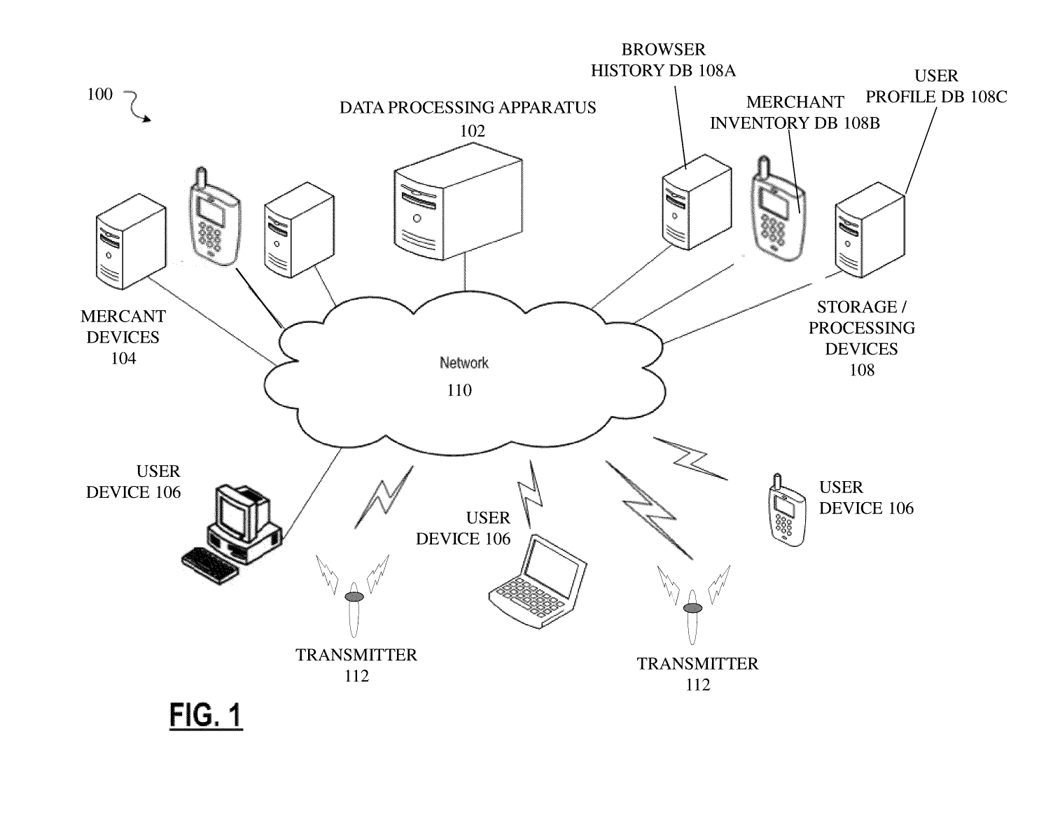

Referring to the drawings, in which like reference numerals refer to like elements, FIG. 1 is a block diagram illustrating an example implementation of the present application and that represents an association of a plurality of devices and the flow of information associated with the devices. In the example shown in FIG. 1, various computing devices 102, 104, 106 and 108 are shown, each capable of executing including INTERNET EXPLORER, CHROME, FIREFOX, and other (e.g., SAFARI, OPERA) desktop and/or mobile computing device web browser application. In addition to standard web browser application functionality, user information can be gathered via Push Notifications, and information can be retrieved from a computing device using a “REST” interface. Various mobile devices running different operating systems are shown, including IOS, ANDROID and other (e.g., PALM, WINDOWS or other mobile device operating system).

In the example shown in FIG. 1, data processing apparatus 102 is operatively coupled to the computing devices 104, 106 and 108. Devices 104, 106 and 108 can be respectively operated by one or more merchants (merchant computing devices 104) and consumers (user computing devices 106). Merchants can include, for example, retail providers of products and/or services, and consumers can include past and/or future purchasers thereof. Storage devices 108 can include one or more computing devices that are operable to store various information including, for example, personal or identifying information about a user, information identifying a respective computing device and/or software operating thereon, user activity (e.g., browsing history, purchase history, information about a respective social network, social actions or activities, profession, preferences or a current location), or the like. In the example implementation illustrated in FIG. 1 the designation of storage computing devices 108 to appear as separate and distinct from merchant computing devices 104 and user computing devices 106. It is to be understood that storage devices 108 do not have to be separate from devices 102, 104 or 106 and that storage devices 108 can be the same as or otherwise comprise a subset of devices 102, 104 and/or 106.

In addition, certain data can be treated in one or more ways before it is stored or used, so that personally identifiable information is not displayed. For example, a person's identification number can be used to retrieve detailed information about a user, and which can be transmitted to a merchant to enable the merchant to provide specialized service. The merchant (or the specific employee or agent of the merchant who interacts with the user) cannot be provided with personally identifiable information about the user. In this way, a user's anonymity can be preserved, for example to maintain expectations of anonymity of typical shoppers in public retail spaces. Also illustrated in FIG. 1 is a network 110, which can be configured as a local area network (LAN), wide area network (WAN), Peer-to-Peer network (“P2P”), Multi-Peer network, the Internet, one or more telephony networks or a combination thereof, that is operable to connect data processing apparatus 102, merchant devices 104, user devices 106 and other devices 108. Though many of the examples and implementations shown and described herein relate to product and/or service recommendations, many other forms of content can be provided and/or delivered by system 100.

Continuing with reference to FIG. 1, transmitter 112 is shown that is configured to transmit wirelessly a signal that can be received by a computing device, such as mobile user computing device 106. As shown in FIG. 1, the transmitter 112 is configured as a stand-alone device that can be configured to send information via network 110 (e.g., via Wi-Fi, BLUETOOTH or other suitable protocol). The transmitter 112 can be configured in various other ways, including as a mobile computing device. Moreover, the transmitter 112 can be configured in various sizes and shapes, and can be, for example, several centimeters in length, and can broadcast hundreds of feet or more. The transmitter 112 can be configured to operate in a send-only mode, in which a signal is transmitted and the transmitter 112 does not receive any acknowledgment or indication that the signal has been received by a device. The transmitter 112 can be configured to transmit a low power radio frequency signal having a frequency range, for example, within about 2.40-2.480 GHz. In one or more implementations, a user computing device 106 is configured with software to receive, recognize and/or respond to the signal, for example, by sending and/or requesting information via network 110 (e.g., a P2P network or Multi-peer network) to one or more of a data processing apparatus 102 and a merchant computing device 104. In one or more implementations, the user computing device(s) 106 can receive a signal from the transmitter 112 without having to establish a connection to the transmitter 112 (e.g., via a BLUETOOTH handshake process). Such a configuration results in improved network performance and battery life.

In one or more implementations, the transmitter 112 is configured with a processor (which can be BLUETOOTH LOW ENERGY (BLTE) compliant) and a power source (e.g., a battery). The signal transmitted by the transmitter 112 can be unique to the respective transmitter 112, and can include a 16 byte identification value, as well as a 2 byte major number, and a 2 byte minor number. In one or more implementation, the 16 byte ID (or other suitable feature of the signal) can be unique and/or associated with a respective company. Further, the values can provide 32 bits of variable content, such as to represent a store, a department, or virtually anything.

Computing devices 106 that are within range of the transmitter's 112 signal can be configured to estimate the distance from the transmitter 112, for example, by determining and measuring the signal strength received from the transmitter 112. The closer the computing device 106 is physically to the transmitter 112, the stronger the signal. Furthermore, a single computing device 106 can receive signals from a plurality of transmitters 112 simultaneously. By determining and measuring the strength of the respective signals, the computing device 106 can determine its relative location with respect to the plurality of transmitters 112. The computing device 106 can transmit information to one more devices 102, 104 108, for example, that identifies its relative position with respect to the transmitters 112. In this way, a precise position of the computing device 106 can be determined and used in accordance with the teachings herein.

Moreover, a computing device (e.g., computing device 106) can be configured to filter for respective identifiers transmitted by transmitter 112. For example, by filtering for specific major and/or minor numbers, an computing device 106 configured with a respective software application can recognize when it is within range of a transmitter 112 associated with a specific company, a transmitter 112 associated with a specific location within a building, or the like. By filtering for specific transmissions provided by transmitter(s) 112, computing devices 102, 104, 106 and 108 operate efficiently, both independently and together.

In one or more implementations, the transmitter transmits 20 bytes of information periodically, such as every 350 milliseconds, so as to increase the likelihood of being received by a user computing device that is suitably configured with software to detect and respond to the signal. In one implementation the user computing device can store software instructions (i.e., “locally”) to detect, interpret and respond to a transmission from the transmitter 112. Alternatively, the user computing device can detect the transmission from the transmitter 112, and, thereafter, transmit information to another computing device (e.g., merchant computing device 104), and/or can execute additional instructions to respond to the transmission appropriately.

In response to a signal transmitted from the transmitter 112 from a computing device 106, one or more of computing devices 102, 104 and 108 can be alerted of a user's presence in a respective location. Accordingly, information requests can be received from one or more devices 102, 104 and 108. The requests that are made can regard, for example, information associated with the user computing device 106 and/or the user operating the device 106. Information retrieved in response to the requests can be processed, for example, to identify one or more specific products and/or services provided by a respective merchant and, thereafter, to form a respective recommendation or suggestion in accordance with the product(s) and/or service(s).

In one or more implementations, an employee or representative of a respective merchant carries a mobile computing device 104, which is configured to broadcast a Peer-to-Peer endpoint, such as via Wi-Fi or BLUETOOTH. When a customer carrying a user computing device 106 that is configured to receive a signal transmitted from transmitter 112 comes within range of the transmitter 112, a software application operating on the computing device 106 becomes active (“wakes”) and detects (automatically, or substantially automatically or manually) to the pre-designated Peer-to-Peer endpoint associated.

In one or more configurations, after the Peer-to-Peer endpoint is detected, the application operating on user computing device 106 provides the computing device 104 with an identification value, such as relating to the customer. Once the identification value is received, the computing device 104 can transmit a request to, for example, the data processing apparatus 102, user computing device 106, computing device 108 or other suitable computing device, for information associated with the customer. For example, a user profile can be requested and/or received by the merchant computing device 108 for access to information, such as the customer's browsing history, purchasing history, demographic information or other stored information.

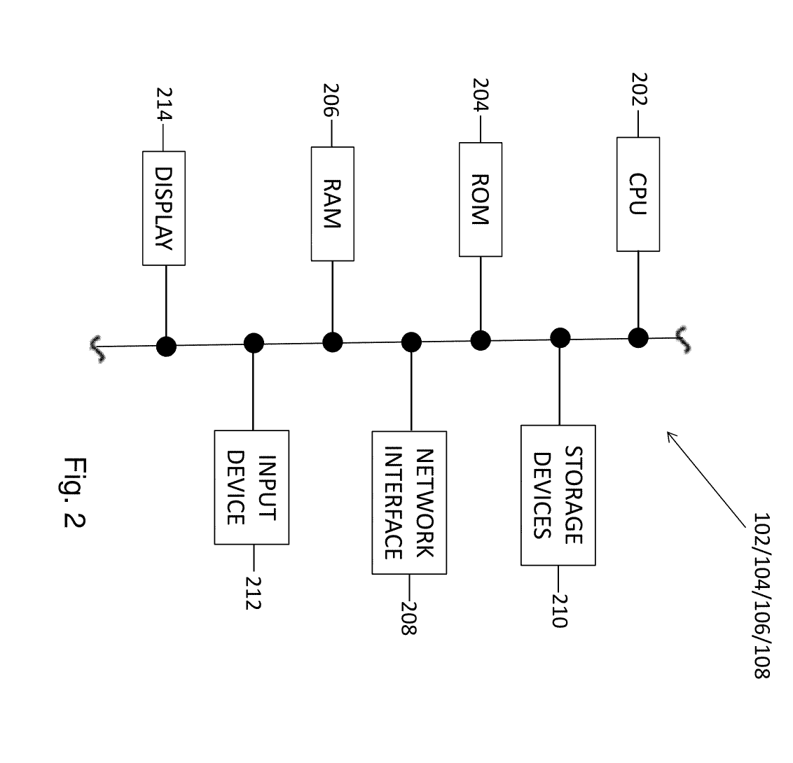

FIG. 2 is a block diagram that illustrates functional elements of one or more of data processing apparatus 102 or computing device (104, 106, 108) and preferably include one or more central processing units (CPU) 202 used to execute software code in order to control the operation of data processing apparatus 102, read only memory (ROM) 204, random access memory (RAM) 206, one or more network interfaces 208 to transmit and receive data to and from other computing devices across a communication network, storage devices 210 such as a hard disk drive, solid state drive, floppy disk drive, tape drive, CD-ROM or DVD drive for storing program code, databases and application code, one or more input devices 212 such as a keyboard, mouse, track ball and the like, and a display 214.

The various components of data processing apparatus 102 need not be physically contained within the same chassis or even located in a single location. For example, as explained above with respect to databases which can reside on storage device 210, storage device 210 may be located at a site which is remote from the remaining elements of data processing apparatuses 102, and may even be connected to CPU 202 across communication network 106 via network interface 208.

The functional elements shown in FIG. 2 (designated by reference numbers 202-214) are preferably the same categories of functional elements preferably present in computing device 104, 106 and/or 108. However, not all elements need be present, for example, storage devices in the case of PDAs, and the capacities of the various elements are arranged to accommodate expected user demand. For example, CPU 202 in computing device 104, 106 and/or 108 may be of a smaller capacity than CPU 202 as present in data processing apparatus 102. Similarly, it is likely that data processing apparatus 102 will include storage devices 210 of a much higher capacity than storage devices 210 present in computing device 104, 106 and/or 108. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, OBJECTIVE C, ANDROID, TORR and various web application development environments.

As used herein, references to displaying data on computing device 104, 106 and/or 108 refer to the process of communicating data to the computing device 104, 106 and/or 108 across communication network 106 and processing the data such that the data can be viewed on the user computing device 104, 106 and/or 108 display 214 using a web browser, custom application or the like. The display screens on computing device 104, 106 and/or 108 present areas within control allocation system 100 such that a user can proceed from area to area within the control allocation system 100 by selecting a desired link. Therefore, each user's experience with control allocation system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 100.

Although the present application is described by way of example herein in terms of a web-based system using web browsers, custom applications and a web site server (data processing apparatus 102), and with mobile computing devices (104) system 100 is not limited to that particular configuration. It is contemplated that control allocation system 100 can be arranged such that computing device 104, 106 and/or 108 can communicate with, and display data received from, data processing apparatus 102 using any known communication and display method, for example, using a non-Internet browser Windows viewer coupled with a local area network protocol such as the Internetwork Packet Exchange (IPX). It is further contemplated that any suitable operating system can be used on computing device 104, 106 and/or 108, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, OSX, LINUX, IOS, ANDROID and any suitable PDA or palm computer operating system.

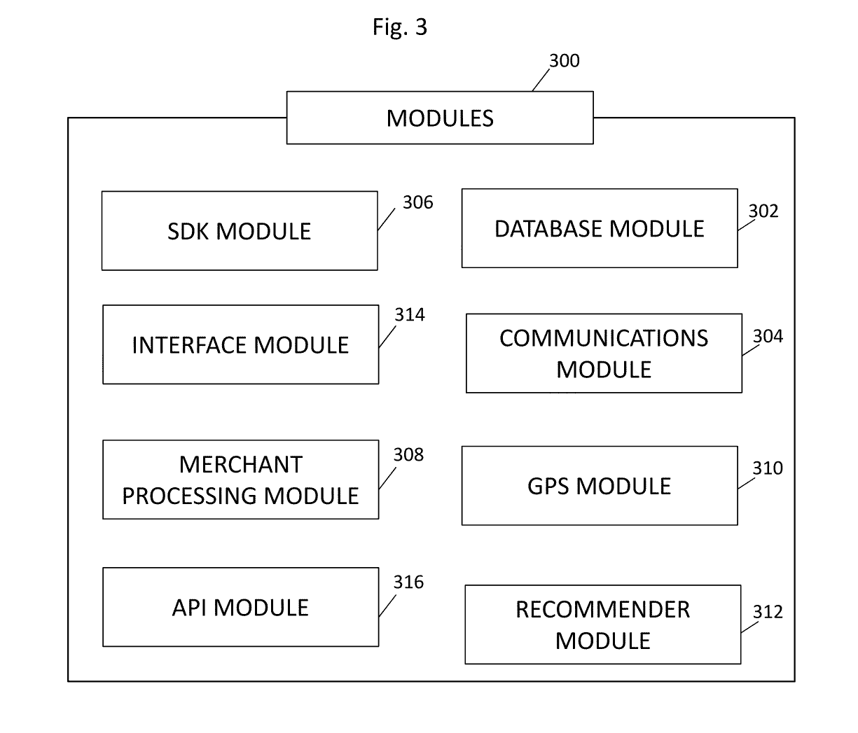

FIG. 3 is a block diagram representing a plurality of modules 300 that provide functionality shown and described herein. Depending upon a respective implementation, the modules 300 can be provided via a single computing device, such as data processing apparatus 102, or can be distributed via a plurality of computing devices, such as computing devices 102, 104, 106 and/or 108. Moreover, one module can be provided via a single computing device (102, 104, 106 or 108), or can be distributed across a plurality of computing devices.

Included in FIG. 3 is database module 302 that can store various information, including that relate to one or more of: identifiers transmitted by respective transmitters 112; respective software applications configured to provide features shown and described herein and operable with user computing devices 106; user profiles that are associated with each of a plurality of users of user computing devices 106; user interest history, such as via web browser history and representational state transfer (“REST”), that can be associated with at least one web page accessed by at least one of the user devices 106; and inventory associated with at least one product and/or service respectively associated with each of a plurality of merchants.

Continuing with reference to FIG. 3, communications module 304 can include hardware and/or software components and configured to interface with at least one of the respective merchant computing devices 104 and/or user computing devices 106 in response to the user computing device 106 detecting and receiving a signal from transmitter 112.

Also illustrated in FIG. 3 is SDK module 306 that is configured to provide tools (e.g., class files, packages or other program resources) that enable software developers to implement features such as shown and described herein. Using the SDK module 306, developers can customize software to operate on user computing devices 106 and configure the devices 106 to detect and/or respond to signals from one or more transmitters 112, such as to transmit information representing, for example, the respective computing devices 106 and/or users thereof to a computing device 104 and/or data processing apparatus 102. The SDK module 306 can be configured to supply appropriate content to a customer's computing device 104 for respective transmitter(s) 112, as well as to transmit tracking information (e.g., tags) for each transmitter 112 that the customer's computing device 106 engages with (or even just approaches).

Continuing with reference to FIG. 3, merchant processing module 308 is configured to interface with one or more merchant-based hardware and software systems, including merchant computing devices 104 and merchant databases 108B, as well as computing devices 106 and data processing apparatus 102. Merchant processing module 308 can include one or more software applications that configure computing devices 104. In one or more implementations, an API Key for merchants can be installed in the software application(s), which can be stored securely, for example, via an operating system (e.g., iOS) level storage.

Continuing with reference to FIG. 3, GPS module 310 can be usable, for example, to identify locations of respective user computing devices 106 and to cause one or more merchant computing devices 104 to receive information associated with merchant database 108B and/or user computing device 106. Further, recommendation module 312 is configured to determine, generate and/or provide one or more recommendations associated with a particular user computing device 106 and/or product/service associated with merchant database 108B. The recommendation(s) can be delivered to a respective merchant computing device 104 that is in close proximity (or other suitable relevance) to user computing device 106. Moreover, information, prompts and graphical screen controls can be provided, for example, on computing devices 104 and/or 106 via interface module 314.

In one or more implementations, the present application can include an application programming interface (“API”) module 316 that enables one or more software applications, for example, operating on user computing device 106, to accept a new beacon object, a default content object, and an array of major number objects, each of which can have an array of minor device numbers. By providing an API in this way, developers to define and/or update information associated detecting and/or responding to particular transmitters 112, as well as particular actions software applications operating on computing devices 102, 104, 106 and/or 108 take in response to detection of signals provided transmitters 112.

For example, a “GET” interface can be provided that receive customer-user-beacon information, identify a particular party (e.g., a merchant), and determine an appropriate beacon content object to return. If none is found a default content object can be returned. The returned object can include two components: user facing information (e.g., HTML content, images, and/or text) and tags. Tags can be transmitted, for example, to data processing apparatus 102, if it appears the user of a computing device 106 has become engaged in the vicinity of respective transmitter 112. Engagement can be time-based (e.g., a minimum period of time that was exceeded in the area), or that the signal strength detected by a computing device 106 became strong (e.g., because a user moved close to the beacon). In one or more implementations, a client software application operating on a user computing device 106 can include settings for identifying a sufficient degree of engagement. Once engaged, tags associated with the transmitter 112 can be transmitted, for example, to data processing apparatus 102.

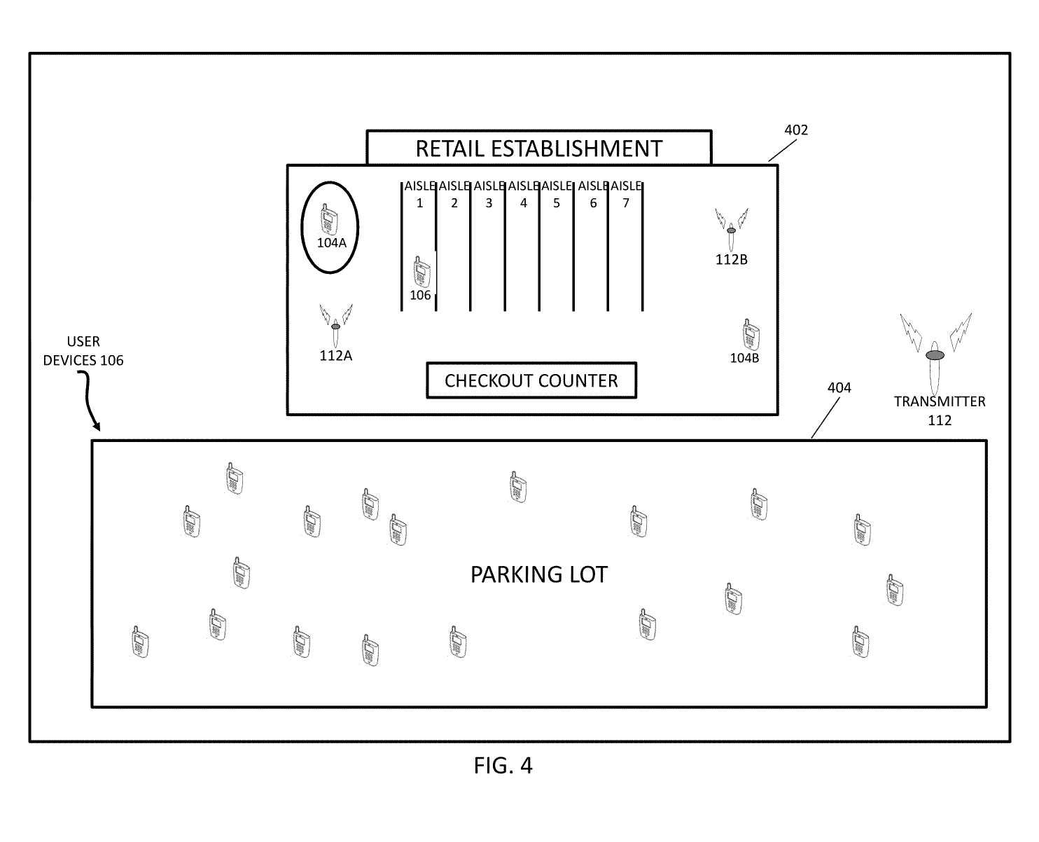

FIG. 4 illustrates an implementation of the present patent application and illustrates an example retail establishment 402 with adjacent parking lot 404. In the retail establishment 402 and adjacent parking lot 404 are a plurality of computing devices 104 and 106. In addition, transmitters 112 are shown and that can be configured to transmit wirelessly a signal such as described above, which can be received by respective user devices 106 that are suitably configured (e.g., with communications hardware and software).

In one or more implementations, when a user computing device 106 detects the signal from a respective transmitter 112, a prompt can be provided on the computing device 106 for the user to launch a software application on the device 106 to enable functionality, such as shown and described herein. In an alternative implementation, the software application on the device 106 can be active and running “in the background,” such as in a multi-tasking computing environment. In such case, when the device 106 detects the signal from the transmitter 112, the software application can appear in the foreground or otherwise execute instructions to provide for the kinds of functionality shown and described herein.

Continuing with reference to FIG. 4, upon such activation of a software application on a respective computing device 106, information can be transmitted from computing device 106 to data processing apparatus 102 and/or merchant computing device 104. Such information can include, for example, an identifier of the user, an identifier of the computing device 106, or other information stored on user computing device 106, such as shown and described above with reference to storage device 108. In addition to stored information, global positioning system information can be received and used to determine specific whereabouts of user computing device 106. For example, user computing device 106 detects a transmitted signal from the transmitter 112, and sends information via network 110 to data processing apparatus 102 and/or merchant computing device 104. The information received from the user computing device 106 is processed to identify information about the user computing device 106 and/or the user. Moreover, the information can be processed to identify one or more products and/or services that can be offered for sale by the retail establishment 302.

For example, the retail establishment 402 is a furniture outlet, and after processing information received from the respective user device 106 (including in response to detecting the signal from the transmitter 112), a determination is made that the user recently browsed a particular kind of chair offered for sale by the furniture outlet. As the user computing device 106 enters or roams the retail establishment 402, information is transmitted from data processing apparatus 102 and/or merchant computing device 104 to a respective merchant computing device 104A or 104B. The information can represent the chair and/or other information, such as the user. In one or more implementations, the selection of the merchant computing device 104A or 104B can depend upon the specific determined location of the user computing device 106 in the retail establishment 402. In the example shown in FIG. 4, the user computing device 106 is located in aisle 1. Using location information associated with the user computing device 106 and the respective merchant computing devices 104A 104B, a determination can be made that device 104A is in closer proximity to the user computing device 106 than device 104B. Using the determination, information is transmitted to device 104A, which can be used by the merchant personnel operating computing device 104A to approach the user operating device 106, for example, to offer a product recommendation or special offer.

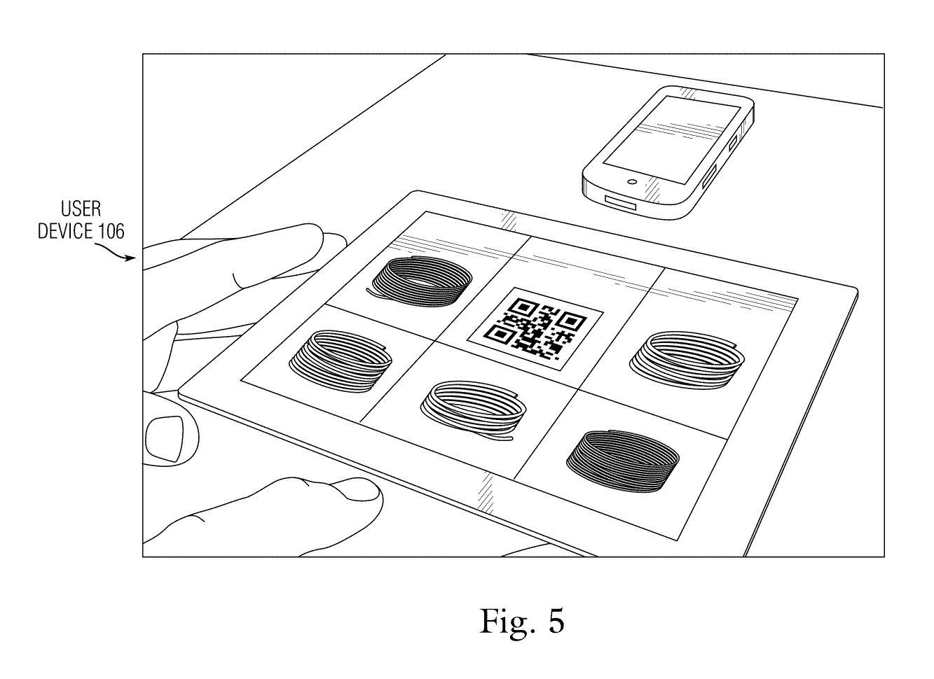

FIG. 5 illustrates an example tablet computing device 106 that is displaying a special offer in the form of a barcode.

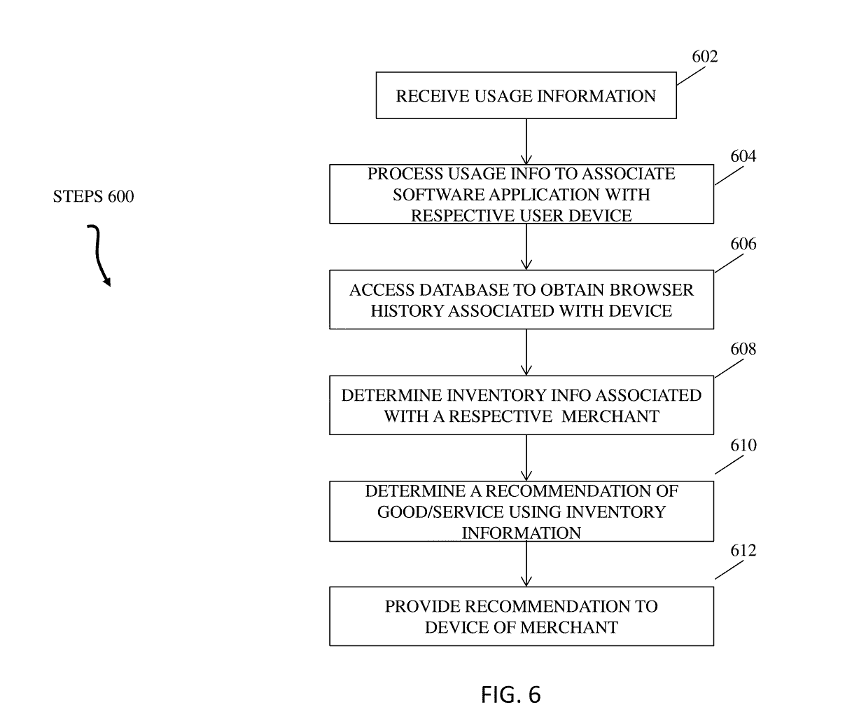

Turning now to FIG. 6, a flow diagram is described showing a routine 600 that illustrates a broad aspect of a method for providing a targeted recommendation for a product or service in accordance with at least one implementation disclosed herein. It should be appreciated that several of the logical operations described herein are implemented (1) as a sequence of computer implemented acts or program modules running on computing device 102/104 and/or (2) as interconnected machine logic circuits or circuit modules within computing device 102/104. The implementation is a matter of choice dependent on the requirements of the device (e.g., size, mobility, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

FIG. 6 is a flowchart illustrating steps 600 associated with an example process for providing a product/service recommendation in accordance with an example implementation. In some implementations, the process 600 can be performed by a processor executing instructions in a computer-readable storage medium, and occurs in response to a user device 106 operating a respective software application that detects transmitter 112. At step 602, electronic use information that is associated with a respective software application is received. The software application may be active on a computing device 106 that is within transmission range of a transmitter 112. Thereafter, the use information is processed to associate the software application with the respective user computing device 106 (step 604). At least one database is accessed to obtain information associated with the user of the computing device 106 (step 606). For example, the databases access to obtain user interest history associated with the user computing device 106. Thereafter at step 608, inventory information associated with the respective merchant is determined. The inventory information is determined based at least on some of the electronic user interest history information associated with the user computing device 106. Using that information, a recommendation of a product and/or service associated with the merchant is determined and/or generated (step 610). Thereafter, the recommendation is provided to a computing device 104 associated with the merchant (step 612). The user of the respective merchant computing device 104 can use the recommendation transmitted in step 612 to approach the user of the computing device 106 to make the product and/or service recommendation in a polite, courteous and respectful way. In this way, the user of computing device 106 does not feel that his or her privacy rights have been encroached or otherwise violated.

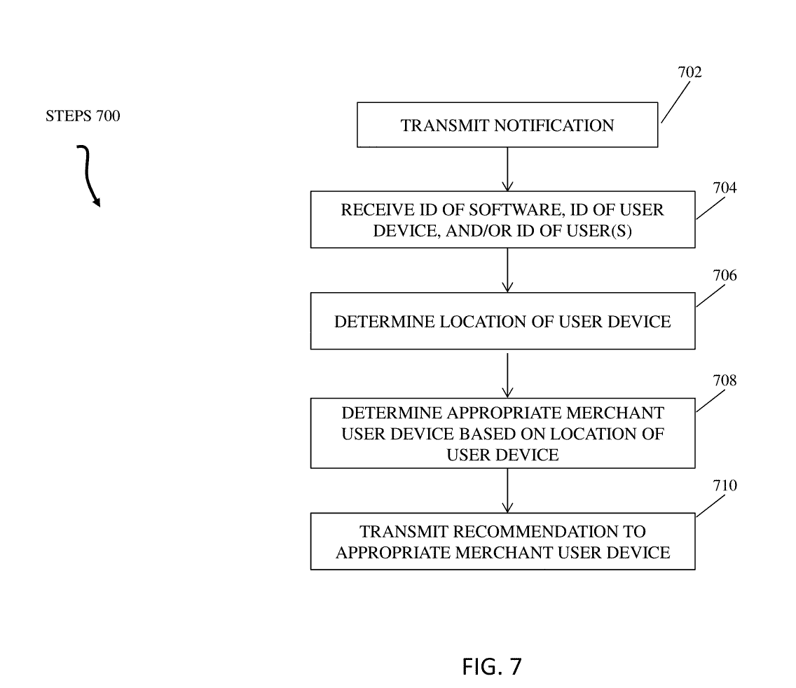

FIG. 7 is another flowchart illustrating example steps 700 associated with an example implementation. In the example steps 700 shown in FIG. 7, a notification is transmitted at step 702 that a respective computing device 106 has received a transmission from transmitter 112. At step 704, information including, for example, after the respective computing device 106 has identified a peer-to-peer endpoint, for example, associated with a merchant and/or the transmitter 112 and an identifier of software, an identifier of the computing device 106 and/or identification of user of computing device 106 is received. The location of the computing device 106 is determined at step 706. Using the information associated with the location of the computing device 106, and appropriate merchant user computing device 104 is determined (step 708). Once the appropriate merchant computing device 104 is identified the recommendation is transmitted to that computing device 104 (step 710). This ensures efficiency in connection with precious moments that would otherwise be lost if a merchant computing device 104 that is not located in close proximity to a user computing device 106 receives the recommendation.

In accordance with the teachings herein, it will be appreciated that many and various implementations of the present application can be applied to this technology. For example, personalized content can be provided as a function of a unique identifier provided by a transmitter 112. Alternatively, generic messaging is supported, such that every user of a computing device 106 is provided the same message for a given transmitter 112. In one context, for example, a museum provides a single content object for a given transmitter 112. In another context, for example, a user at an airport is told “Your plane is at Gate C99 and you are walking the wrong way.” The present application leverages information accessible from a plurality of sources, and provides a new and powerful way to engage users without infringing on their personal space or invading the privacy.

The subject matter described above is provided by way of illustration only and should not be construed as limiting. Various modifications and changes can be made to the subject matter described herein without following the example embodiments and applications illustrated and described, and without departing from the true spirit and scope of the present invention, as set forth in each and any of the following claims.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an internetwork (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for providing a targeted recommendation for a product or service, the method comprising:
accessing, using at least one processor, at least one database that includes:
electronic software application information associated with at least one respective software application provided to each of a plurality of users;
electronic profile information associated with each of the plurality of respective users; and
electronic user interest history information associated with at least one web page accessed by at least one of a plurality of respective user devices;
receiving over a data communication network, using the at least one processor, electronic use information associated with a respective one of the software applications that is active within a respective location at a respective time;
processing, using the at least one processor, the electronic use information to associate the one respective software application with a respective one of the plurality of user devices;
determining, using the at least one processor and based on at least some of the electronic user interest history information associated with the respective user device, a recommendation of a product and/or service associated with one merchant; and
providing the recommendation to a computing device operated by a person associated with the one merchant.

2. The method of claim 1, wherein receiving the electronic use information further comprises:
transmitting, using at least one transmitter, a notification that is receivable by the respective user device; and
receiving, in response to the transmitted notification from the respective user device, the electronic use information.

3. The method of claim 2, wherein the notification is transmitted wirelessly over a low power radio frequency signal having a frequency range within about 2.40-2.480 GHz.

4. The method of claim 1, wherein the electronic use information further includes at least one of:
an identifier of a copy of the respective one software application;
an identifier of the respective user device configured with the respective one software application; and
an identifier of the one of the plurality of users.

5. The method of claim 2, wherein providing the recommendation further comprises:
determining, using the at least one processor, a location of the respective user device; and
transmitting, using the at least one processor, the recommendation to the at least one computing device operated by the person associated with the one merchant based at least on the location of the respective user device.

6. The method of claim 5, wherein determining the location of the respective user device is performed as a function of at least one of:
a global positioning system; and
a location of the at least one transmitter and a value representing a signal strength of the notification received by the respective user device.

7. The method of claim 5, further comprising:
identifying, using the at least one processor, a plurality of computing devices that are each respectively operated by at least one person associated with the one merchant, and
determining, using the at least one processor and based at least on the location of the respective user device, a respective computing device operated by the at least one person associated with the one merchant.

8. The method of claim 2, wherein the at least one transmitter includes a plurality of transmitters, and wherein determining the location of the respective user device is further performed as a function of the respective locations of each of the transmitters and values respectively representing signal strengths of the notifications transmitted by each of the respective transmitters and received by the user device.

9. The method of claim 1, wherein the at least some of the electronic user interest history information associated with the respective user device represents at least one of:
a web site visited by the one of the plurality of users;
a product and/or service viewed by the one of the plurality of users; and
an advertisement provided to the one of the plurality of users.

10. The method of claim 1, wherein the recommendation includes a special offer.

11. The method of claim 1, wherein the at least one database further includes electronic inventory information associated with at least one product and/or service respectively associated with each of a plurality of merchants; and
further wherein the step of determining the recommendation is based on at least some of the electronic inventory information associated with the one merchant.

12. A system for providing a targeted recommendation for a product or service, the system comprising:
processor readable media;
at least one processor operatively coupled to the processor readable media;
at least one database stored on the processor readable media, the at least one database comprising:
electronic software application information associated with at least one respective software application provided to each of a plurality of users; and
electronic profile information associated with each of the plurality of respective users;
electronic user interest history information associated with at least one web page accessed by at least one of a plurality of respective user devices;
the processor readable media having instructions for causing the following steps to be performed by the at least one processor;
receiving over a data communication network, using the at least one processor, electronic use information associated with a respective one of the software applications that is active within a respective location at a respective time;
processing, using the at least one processor, the electronic use information to associate the one respective software application with a respective one of the plurality of user devices;
determining, using the at least one processor and based on at least some of the electronic user interest history information associated with the respective user device, a recommendation of a product and/or service associated with the one merchant; and
providing the recommendation to a computing device operated by a person associated with the one merchant.

13. The system of claim 12, wherein the processor readable media have instructions for causing the following step to be performed by the at least one processor:
transmitting, using at least one transmitter, a notification that is receivable by the respective user device; and
receiving, in response to the transmitted notification from the respective user device, the electronic use information.

14. The system of claim 13, wherein the notification is transmitted wirelessly over a low power radio frequency signal having a frequency range within about 2.40-2.480 GHz.

15. The system of claim 12, wherein the electronic use information further includes at least one of:
an identifier of a copy of the respective one software application;
an identifier of the respective user device configured with the respective one software application; and
an identifier of the one of the plurality of users.

16. The system of claim 13, wherein the processor readable media have instructions for causing the following step to be performed by the at least one processor:
determining, using the at least one processor, a location of the respective user device; and
transmitting, using the at least one processor, the recommendation to the at least one computing device operated by the person associated with the one merchant based at least on the location of the respective user device.

17. The system of claim 16, wherein determining the location of the respective user device is performed as a function of at least one of:
a global positioning system; and
a location of the at least one transmitter and a value representing a signal strength of the notification received by the respective user device.

18. The system of claim 16, wherein the processor readable media have instructions for causing the following step to be performed by the at least one processor:
identifying, using the at least one processor, a plurality of computing devices that are each respectively operated by at least one person associated with the one merchant, and
determining, using the at least one processor and based at least on the location of the respective user device, a respective computing device operated by the at least one person associated with the one merchant.

19. The system of claim 12, wherein the at least some of the electronic user interest history information associated with the respective user device represents at least one of:
a web site visited by the one of the plurality of users;
a product and/or service viewed by the one of the plurality of users; and
an advertisement provided to the one of the plurality of users.

20. The system, of claim 12, wherein the recommendation includes a special offer.

21. The system of claim 12, wherein the at least one database further includes electronic inventory information associated with at least one product and/or service respectively associated with each of a plurality of merchants; and
further wherein the step of determining the recommendation is based on at least some of the electronic inventory information associated with the one merchant.

22. The system of claim 13, wherein the at least one transmitter includes a plurality of transmitters, and wherein determining the location of the respective user device is further performed as a function of the respective locations of each of the transmitters and values respectively representing signal strengths of the notifications transmitted by each of the respective transmitters and received by the user device.
